(19) United States
(12) Patent Application Publication
(10) Pub. No.: US 2015/0343942 A1
(43) Pub. Date: Dec. 3, 2015

(54) Illuminated Lug Nut Cover

(71) Applicant: Virginia Vaughn, Bottineau, ND (US)

(72) Inventor: Virginia Vaughn, Bottineau, ND (US)

(21) Appl. No.: 14/714,510

(22) Filed: May 18, 2015

Related U.S. Application Data
(60) Provisional application No. 62/004,588, filed on May 29, 2014.

(51) Int. Cl. B60Q 1/32; B60Q 1/00; B60Q 1/26; B60B 7/00; F16B 37/14

(52) U.S. Cl. CPC B60Q 1/326; B60B 7/006; F16B 37/14; B60Q 1/2696; B60Q 1/0088

(57) ABSTRACT

An illuminated lug nut cover for installation on the lug nut of a vehicle wheel. The lug nut cover includes a body having a light source on a first end thereof and a recessed area on a second end thereof. The recessed area can be secured onto the lug nut of a vehicle so as to enclose the lug nut therein. The body may include a kinetic generator or solar panel for producing electricity sufficient to cause the light source to illuminate. The body may additionally include a battery that serves as the power source, or that is used to store electricity produced by the kinetic generator or solar panel. Thus, the present invention provides an illuminated lug nut cover for providing light on the wheels of a vehicle, such as a commercial vehicle, to improve the visibility thereof.

### CROSS REFERENCE TO RELATED APPLICATION

This application claims the benefit of U.S. Provisional Application No. 62/004,588 filed on May 29, 2014. The above identified patent application is herein incorporated by reference in its entirety to provide continuity of disclosure.

### BACKGROUND OF THE INVENTION

### Field of the Invention

The present invention relates to lug nut covers for vehicles. More specifically, the present invention provides an illuminated lug nut cover comprising a body having a first end with a light source thereon and a second end having a recessed area adapted to receive a lug nut therein. The lug nut cover can be secured to a lug nut and includes a power source, such as a battery, solar panel, or kinetic generator, among others for illuminating the light source.

Commercial vehicles, such as tractor trailers, often have lights on the front and rear portions thereof. However, such vehicles lack signal or warning lights on the sides thereof. As a result, tractor trailers can be difficult to see at night or in the fog when viewed from the side. Accidents may occur on the road if other drivers are unable to see the tractor trailer due to the lack of lights on the side of the vehicle. As a result, lights securable to the wheels of a vehicle are desired in order to make the vehicle more visible to other drivers.

Devices have been disclosed in the prior art that relate to vehicle wheel lighting devices. These include devices that have been patented and published in patent application publications. U.S. Published Patent Application Number 2007/0274085, U.S. Pat. No. 7,150,549, U.S. Published Patent Application Number 2005/0036297, and U.S. Pat. No. 8,075,170 relate to lighting systems for vehicle wheels. Other devices relate to antitheft systems for securing a wheel rim, such as U.S. Pat. No. 8,525,653.

These prior art devices have several known drawbacks. Such devices provide decorative lights on the wheel or rim of a vehicle, but fail to provide lights securable to the lug nuts of the wheel. Thus, other fastening means must be used to secure the lights to the wheel or rim. Further, the devices in the prior art fail to provide the use of solar panels or kinetic generators for providing power to the lights.

In light of the devices disclosed in the prior art, it is submitted that the present invention substantially diverges in design elements from the prior art and consequently it is clear that there is a need in the art for an improvement to existing lug nut cover devices. In this regard the instant invention substantially fulfills these needs.

### SUMMARY OF THE INVENTION

In view of the foregoing disadvantages inherent in the known types of wheel lighting systems now present in the prior art, the present invention provides a new illuminated lug nut cover wherein the same can be utilized for providing convenience for the user when illuminating the wheels of a vehicle, such as a tractor trailer.

It is therefore an object of the present invention to provide a new and improved illuminated lug nut cover device that has all of the advantages of the prior art and none of the disadvantages.

It is another object of the present invention to provide an illuminated lug nut cover comprising a body having a light source on a first end thereof and having a recessed area adapted to receive a lug nut on a second end thereof.

Another object of the present invention is to provide an illuminated lug nut cover having a kinetic generator for powering the light source thereon.

Yet another object of the present invention is to provide an illuminated lug nut cover having a solar panel for producing electricity for powering the light source thereon.

A further object of the present invention is to provide an illuminated lug nut cover having a battery for storing electricity required to cause the light source to illuminate.

Another object of the present invention is to provide an illuminated lug nut cover device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the illuminated lug nut cover.

FIG. 2A shows a cross sectional view of an embodiment of the illuminated lug nut cover.

FIG. 2B shows a cross sectional view of an alternate embodiment of the illuminated lug nut cover.

### DETAILED DESCRIPTION OF THE INVENTION

Reference is made herein to the attached drawings. Like reference numerals are used throughout the drawings to depict like or similar elements of the illuminated lug nut cover. For the purposes of presenting a brief and clear description of the present invention, the preferred embodiment will be discussed as used for illuminating the wheels of a vehicle to improve visibility of the side of the vehicle. The figures are intended for representative purposes only and should not be considered to be limiting in any respect.

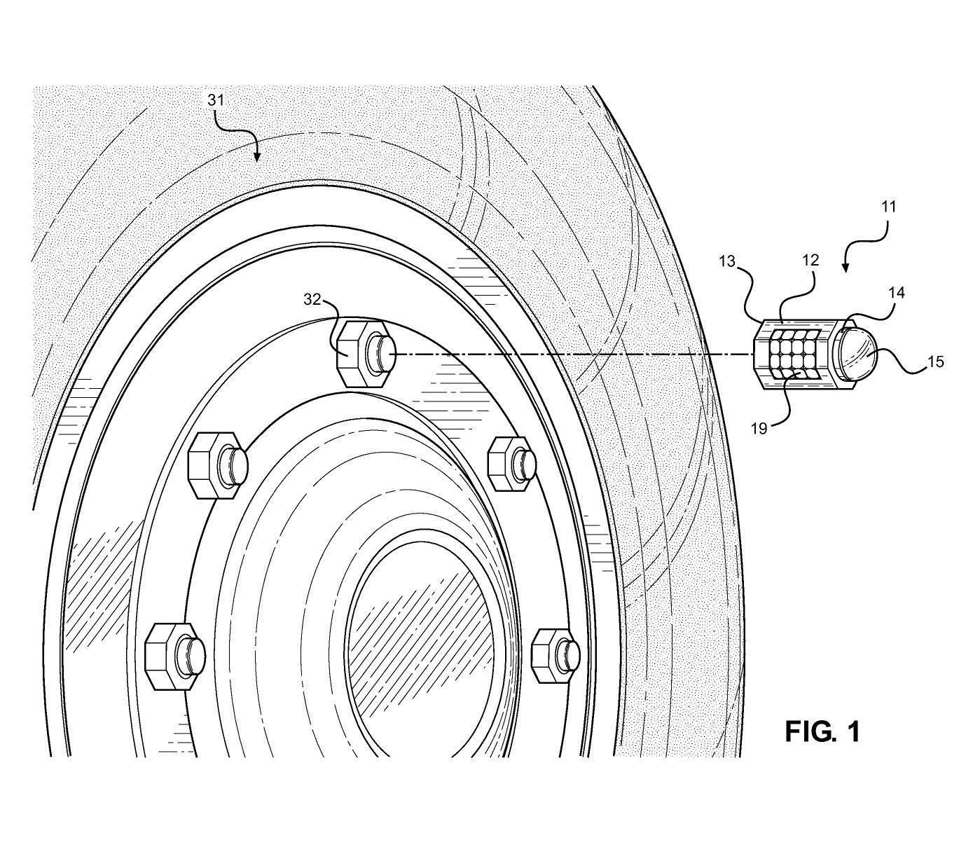

Referring now to FIG. 1, there is shown a perspective view of an embodiment of the illuminated lug nut cover. The illuminated lug nut cover 11 comprises a body 12 having a first end 14 opposite a second end 13. The body 12 is preferably cylindrical but may include alternate configurations to accommodate lug nuts of different shapes such as one having a hexagonal body. The second end 13 includes a recessed area adapted to receive a lug nut 32 therein. Thus, the recessed area is sized and shaped so as to fit around the outer perimeter of the lug nut 32 such that the entirety of the lug nut 32 is positioned within the recessed area. Further, the recessed area may be contoured similarly to the shape of the lug nut 32 so that the lug nut cover 11 fits flush thereagainst. The second end 13 can be fitted onto a lug nut 32 by press fit or can be screwed or twisted onto the lug nut 32, depending upon the embodiment. The lug nut cover 11 may alternately comprise a fastener such as a magnet for securement to the lug nut 32.

The first end 14 of the body 12 includes one or more light sources 15 thereon. The light sources 15 are preferably LEDs so as to provide high brightness with low power consumption. The light sources 15 may include a plurality of LEDs arranged into a decorative pattern, such as a star, heart, square, or circle, among others. Alternatively, the light source 15 may include a single LED thereon. The light sources 15 may be enclosed within a transparent cover or lens so as to protect the light sources 15 from damage due to contact with debris due to exposure to precipitation or moisture. Thus, the body 12 and light sources 15 have a waterproof and durable construction so as to resist damage or deterioration from exposure to the environment.

The light sources 15 are powered by a power source. In the illustrated embodiment, the power source comprises one or more solar panels 19 mounted onto the body 12 of the illuminated lug nut cover 11. The solar panels 19 are in electrical communication with the light sources 15 so as to provide power thereto. The solar panels 19 may be disposed on a portion of the body 12 between the first and second ends 13, 14 thereof. An electrical storage means, such as a battery or capacitor, may further be included so that solar energy collected during the day can be used during the night in order to illuminate the light sources 15. A light sensor may further be provided so that the light source 15 of the lug nut cover 11 only illuminates during periods of low ambient light, such as at night.

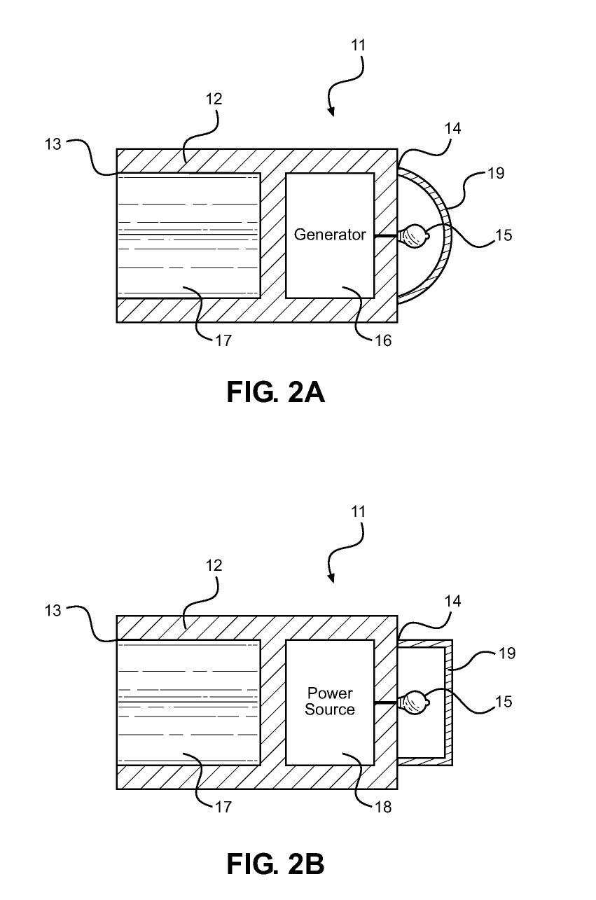

Referring now to FIGS. 2A and 2B, there are shown cross sectional views of alternative embodiments of the illuminated lug nut cover. The body 12 of the illuminated lug nut cover 11 comprises a first end 14 having one or more light sources 15 thereon and includes a second end 13 having a recessed area 17 adapted to receive a lug nut therein. The body 12 further includes a generator 16 or power source 18, depending upon the embodiment. In some embodiments, the body 12 encloses a battery for providing electricity to the light sources 15 thereon. One or more batteries may be used, and the batteries may be disposable or rechargeable. Alternatively, the battery may adapted to store energy produced by the solar panel or kinetic generator.

In embodiments having a generator 18, the generator 18 is preferably a kinetic generator adapted to produce electricity when the illuminated lug nut cover 11 is in motion. In this way, the kinetic generator can produce electricity to power the light source 15 while the wheels on which the illuminated lug nut covers 11 are installed are in motion. Thus, the light sources 15 will be illuminated when the vehicle is in motion and the light sources will not be illuminated when the vehicle is parked or is motionless. In this way, the vehicle can be more easily seen from the side while in motion, and there is no need for the user to replace or recharge batteries.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminated lug nut cover, comprising:
a body having a first end and a second end;
said first end comprising one or more light sources;
said second end comprising a recessed area adapted to receive a lug nut therein;
a means for providing electricity to said one or more light sources.

2) The illuminated lug nut cover of claim 1, wherein said body is substantially cylindrical.

3) The illuminated lug nut cover of claim 1, wherein said body is hexagonal in configuration.

4) The illuminated lug nut cover of claim 1, wherein said one or more light sources are LEDs.

5) The illuminated lug nut cover of claim 1, wherein said one or more light sources are arranged in a decorative pattern.

6) The illuminated lug nut cover of claim 1, wherein said means for providing electricity comprises one or more batteries.

7) The illuminated lug nut cover of claim 1, wherein said means for providing electricity comprises a kinetic generator enclosed within said body and adapted to produce electricity when said body is in motion.

8) The illuminated lug nut cover of claim 1, wherein said means for producing electricity comprises a solar panel disposed on said body.
